(19) United States
(12) Patent Application Publication
(10) Pub. No.: US 2023/0299814 A1
(43) Pub. Date: Sep. 21, 2023

(54) BASE STATION, COMMUNICATION METHOD, AND COMMUNICATION PROGRAM

(71) Applicant: NIPPON TELEGRAPH AND TELEPHONE CORPORATION, Tokyo (JP)

(72) Inventors: Akira KISHIDA, Musashino-shi, Tokyo (JP); Kengo NAGATA, Musashino-shi, Tokyo (JP); Yasuhiko INOUE, Musashino-shi, Tokyo (JP); Yusuke ASAI, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/016,832

(22) PCT Filed: Jul. 27, 2020
(86) PCT No.: PCT/JP2020/028674

§ 371 Date: Jan. 18, 2023

(51) Int. Cl. H04B 7/024; H04W 74/08

(52) U.S. Cl. CPC H04B 7/024; H04W 74/0808

(57) ABSTRACT

A base station (10-1) includes a radio signal processing unit (102) capable of using a first channel (CH4), a second channel (CH3), and a third channel (CH2). The radio signal processing unit is configured to perform signaling with a second other base station (10-3) using the second channel while performing signaling with a first other base station (10-4) using the first channel when the radio signal processing unit acquires transmission rights of the first channel, the second channel, and the third channel, and execute cooperative processing with at least one of the first other base station and the second other base station on the basis of a result of the signaling.

### TECHNICAL FIELD

An embodiment relates to a base station, a communication method, and a communication program.

### BACKGROUND ART

A base station and a terminal of a wireless LAN access a channel using Carrier sense multiple access with collision avoidance (CSMA/CA) to transmit radio signals. In CSMA/CA, the base station and the terminal confirm that a channel is not in use by another terminal or the like through carrier sense while waiting for a time defined by an access parameter, and then transmit radio signals.

When it is confirmed that all of a plurality of channels are not in use, the base station can regard transmission rights of the plurality of channels as having been acquired, and transmit a radio signal using both sides.

### CITATION LIST

### Non Patent Literature

[NPL 1] IEEE Std 802.11-2016, “10.22.2.5 EDCA channel access in a VHT or TVHT BSS”, 7 Dec. 2016
[NPL 2] IEEE P802.11ax/D6.0, “10.23.2.5 EDCA channel access in a VHT, HE or TVHT BSS”, 26 Nov. 2019

### SUMMARY OF INVENTION

### Technical Problem

However, when one base station acquires transmission rights of a plurality of channels, another base station that could not acquire the transmission rights of the plurality of channels cannot transmit radio signals using the plurality of channels. When there is little data to be transmitted in the base station that has acquired the transmission rights of the plurality of channels, unused channels are likely to occur even though there are base stations that cannot transmit data because the base stations have not acquired transmission rights, which is not preferable. That is, there is room for consideration in efficiently using channels among a plurality of base stations.

The present invention has been made in view of the above circumstances, and an object of the present invention is to provide a wireless communication environment in which channels can be efficiently used among a plurality of base stations.

### Solution to Problem

A base station according to an aspect is a base station including a radio signal processing unit capable of using a first channel, a second channel, and a third channel. The radio signal processing unit is configured to perform signaling with a second other base station using the second channel while performing signaling with a first other base station using the first channel when the radio signal processing unit acquires transmission rights of the first channel, the second channel, and the third channel, and execute cooperative processing with at least one of the first other base station and the second other base station on the basis of a result of the signaling.

### Advantageous Effects of Invention

According to the embodiment, it is possible to provide a wireless communication environment in which channels can be efficiently used among a plurality of base stations.

### BRIEF DESCRIPTION OF DRAWINGS

FIG. 1 is a block diagram illustrating a configuration of a communication system according to an embodiment.

FIG. 2 is a block diagram illustrating a hardware configuration of a base station according to the embodiment.

FIG. 3 is a block diagram illustrating a functional configuration of a base station according to the embodiment.

FIG. 4 is a conceptual diagram illustrating a slave candidate station management table that is stored in the base station according to the embodiment.

FIG. 5 is a flowchart illustrating negotiation processing that is executed between base stations according to the embodiment.

FIG. 6 is a flowchart illustrating data transmission processing that is executed in a plurality of base stations according to the embodiment.

FIG. 7 is a timing chart illustrating cooperative data transmission processing that is executed in a plurality of base stations according to the embodiment.

FIG. 8 is a timing chart illustrating data that is communicated between a base station and a terminal in the cooperative transmission processing according to the embodiment.

FIG. 9 is a timing chart illustrating cooperative data transmission processing that is executed in a plurality of base stations according to a first modification example.

FIG. 10 is a timing chart illustrating cooperative data transmission processing that is executed in a plurality of base stations according to a second modification example.

### DESCRIPTION OF EMBODIMENTS

An embodiment will be described below with reference to the drawings. In the following description, components having the same functions and configurations are denoted by common reference signs. Further, when a plurality of components having common reference signs are distinguished, the components are distinguished by further reference signs added following the common reference signs (for example, a hyphen and numeral such as “−1”).

### 1. Embodiment

### 1.1 Configuration

A configuration of a wireless communication system according to an embodiment will be described.

### 1.1.1 Wireless Communication System

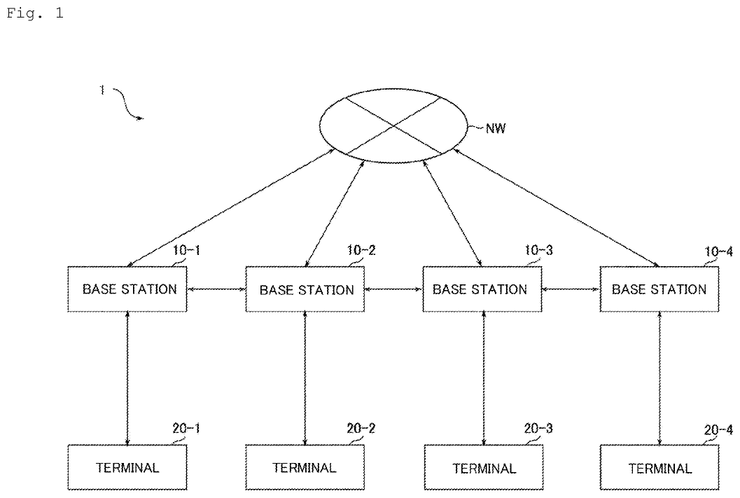

FIG. 1 is a block diagram illustrating an example of a configuration of the wireless communication system according to the embodiment.

The wireless communication system 1 includes a plurality of base stations 10-1, 10-2, 10-3, and 10-4, and a plurality of terminals 20-1, 20-2, 20-3, and 20-4, as illustrated in FIG. 1. Hereinafter, when the plurality of base stations 10-1 to 10-4 are not particularly distinguished, the base stations may be referred to as “base stations 10”. Further, when the plurality of terminals 20-1 to 20-4 are not particularly distinguished, the terminals may be referred to as “terminals 20”.

Each of the plurality of base stations 10-1 to 10-4 has a service area that is set in advance (not illustrated), and is capable of communicating with the terminal 20 within the service area. Each of the plurality of base stations 10-1 to 10-4 connects the terminal 20 within its service area and a network NW, and functions as an access point for allowing the terminal 20 within the service area to access the network NW.

Further, the plurality of base stations 10-1 to 10-4 can communicate with each other, and can execute cooperated data transmission (a cooperative data transmission) in a frequency domain by sharing information on frequency bands (channels) and the like to be used for communication. Details of cooperative data transmission processing in the frequency domain will be described below.

The terminal 20 is a wireless terminal such as a smartphone, a personal computer (PC), or the like, for example. The terminal 20 is configured to be able to transmit or receive data to or from the network NW via the plurality of base stations 10-1 to 10-4. In the example in FIG. 1, a case in which the respective terminals 20-1 to 20-4 belong to within service areas of all of the plurality of base stations 10-1 to 10-4 is illustrated.

### 1.1.2 Base Station

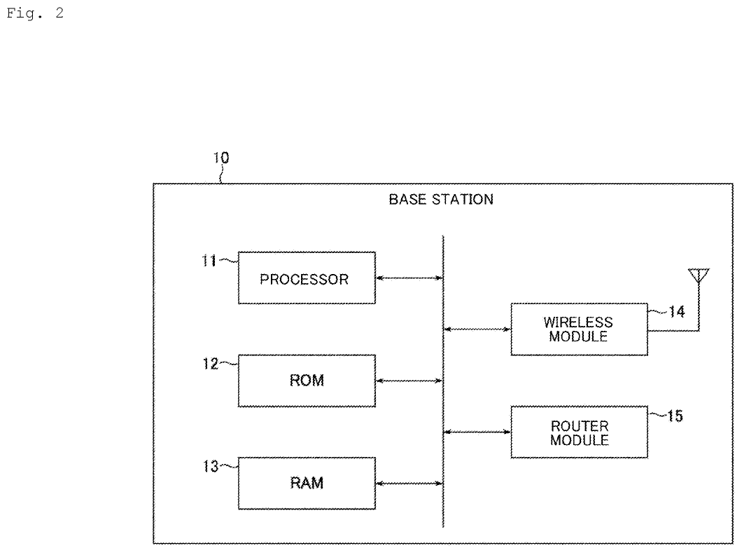

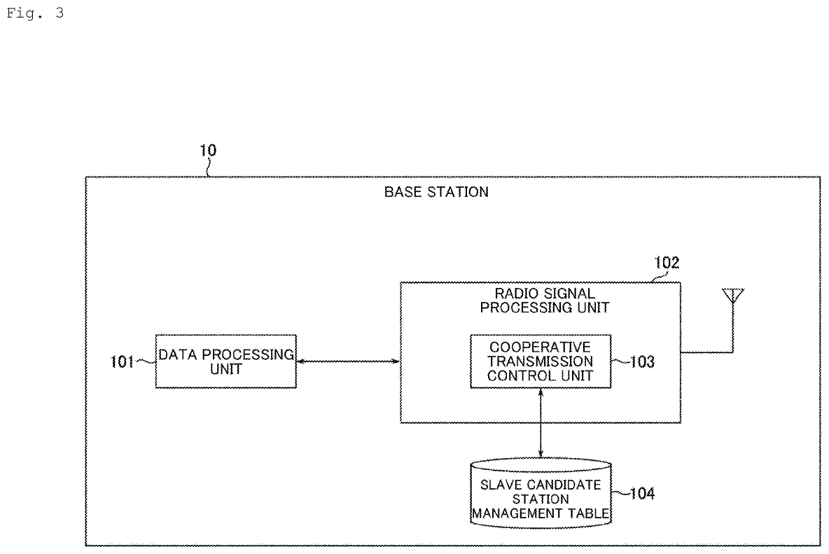

FIG. 2 and FIG. 3 are respective block diagrams illustrating an example of a hardware configuration and a functional configuration of the base station according to the embodiment. The plurality of base stations 10-1 to 10-4 in FIG. 1 may have the same configuration. In FIG. 2 and FIG. 3, a configuration of any one base station 10 of the plurality of base stations 10-1 to 10-4 is illustrated.

First, a hardware configuration of the base station 10 will be described with reference to FIG. 2.

As illustrated in FIG. 2, the base station 10 includes a processor 11, a read only memory (ROM) 12, a random access memory (RAM) 13, a wireless module 14, and a router module 15.

The processor 11 is a processing device that controls the entire base station 10. The processor 11 is, for example, a central processing unit (CPU), but is not limited thereto, and an application specific integrated circuit (ASIC) or the like may be used instead of the CPU. The ROM 12 is a nonvolatile semiconductor memory, for example, and stores firmware and various types of programs necessary for an operation of the base station 10. The RAM 13 is volatile semiconductor memory, for example, and is used as a work area for the processor 11.

The wireless module 14 is a circuit that is used for transmission and reception of data using radio signals, and is connected to an antenna. The router module 15 is provided for the base station 10 to communicate with a server (not illustrated) within the network NW, for example.

Next, a functional configuration of the base station 10 will be described with reference to FIG. 3.

As illustrated in FIG. 3, the base station 10 functions as a computer including a data processing unit 101 and a radio signal processing unit 102. The data processing unit 101 and the radio signal processing unit 102 are functional blocks for performing data communication on the basis of an Open systems interconnection (OSI) reference model. In the OSI reference model, communication functions are divided into seven layers (first layer: physical layer, second layer: data link layer, third layer: network layer, fourth layer: transport layer, fifth layer: session layer, sixth layer: presentation layer, and seventh layer: application layer). The data link layer includes a logical link control (LLC) layer and a media access control (MAC) layer. In the present specification, the third layer to the seventh layer are referred to as “higher layers”, with the data link layer of the second layer as a reference.

The data processing unit 101 executes processing corresponding to the LLC layer and higher layers on the input data. For example, the data processing unit 101 outputs the data input from the network NW to the radio signal processing unit 102. The data processing unit 101 also outputs data input from the radio signal processing unit 102 to the network NW.

The radio signal processing unit 102 executes processing of an MAC layer and a physical layer for the input data, and performs transmission and reception of data between the base station 10 and the terminal 20 or between the base station 10 and another base station 10, using wireless communication. For example, the radio signal processing unit 102 creates radio frames (for example, MAC frames) using data input from the data processing unit 101, converts the radio frames into radio signals, and sends the radio signals to the terminal 20 or the other base station 10 via the antenna. The radio signal processing unit 102 also converts the radio signals received via the antenna into radio frames, and outputs data included in the radio frames to the data processing unit 101.

Here, the radio signal processing unit 102 may perform control according to a degree of priority in transmission by allocating radio frames to a plurality of transmission queues. For example, the radio signal processing unit 102 may have a plurality of transmission queues AC_LL, AC_VO, AC_VI, AC_BE, and AC_BK, for each access category (AC). The transmission queue AC_LL is a queue for holding radio frames categorized into low latency (LL). The transmission queue AC_VO is a queue for holding radio frames categorized into Voice (VO). The transmission queue AC_VI is a queue for holding radio frames categorized into Video (VI). The transmission queue AC_BE is a queue for holding radio frames categorized into Best effort (BE). The transmission queue AC_BK is a queue for holding radio frames categorized into Background (BK). The radio signal processing unit 102 inputs the radio frame to the corresponding transmission queue according to a category of data recorded in the radio frame.

The radio signal processing unit 102 confirms, for each access category, that there is no transmission of radio signals by other base stations or the like on the channel to be used for transmission or reception of data through carrier sense. Specifically, the radio signal processing unit 102 waits for transmission for a time defined by an access parameter set for each access category (for example, Arbitration inter frame space (AIFS) and random back-off). The above-described access parameters are allocated such that transmission of radio signals are relatively prioritized in order of LL, VO, VI, BE, and BK, for example. When a reception power is smaller than a threshold value while transmission is waited for, the radio signal processing unit 102 regards the own station as having acquired the transmission right of the channel, extracts the radio frame from the corresponding transmission queue, converts the radio frame into a radio signal based on a predetermined channel, and transmits the radio signal. The radio signal processing unit 102 has an individual set value TXOPlimit for each access category, and can continuously transmit a radio signal during the set value TXoPlimit once the radio signal processing unit 102 acquires a transmission right of the channel.

When there are a plurality of channels to be used, the radio signal processing unit 102 executes the carrier sense processing described above for each of the plurality of channels in parallel.

The radio signal processing unit 102 according to the present embodiment includes a cooperative transmission control unit 103. The cooperative transmission control unit 103 controls cooperative transmission processing in a frequency domain that is executed between the base station 10 that is the own station and the other base station 10, on the basis of a slave candidate station management table 104. The cooperative transmission processing is processing in which a base station that has acquired transmission rights for a plurality of channels executes Orthogonal Frequency Division Multiple Access (OFDMA) using the plurality of channels in a cooperated manner with a base station that could not acquire the transmission right.

Hereinafter, a base station which has acquired transmission rights of a plurality of channels is called a “master station”, and a base station that executes the cooperative transmission processing with the master station is called a “slave station” at the time of the cooperative transmission processing so that the stations are distinguished from each other, as necessary.

Specifically, the cooperative transmission control unit 103 executes negotiation processing with the other base station 10 capable of communication prior to processing for data transmission to the terminal 20. As a result of the negotiation processing, the cooperative transmission control unit 103 determines the base station 10 (a slave station) capable of executing the cooperative transmission processing as a slave station when the own station becomes a master station, and a channel (an allocation channel) that the slave candidate station uses in the cooperative transmission processing. Information on the slave candidate station and the allocation channel is stored in the slave candidate station management table 104 in the base station 10, for example. Details of the negotiation processing will be described below.

When the own station becomes the master station, the cooperative transmission control unit 103 generates an invite signal for requesting the slave candidate station to participate in the cooperative transmission processing as a slave station on the basis of the slave candidate station management table 104. When a response signal to the invite signal is received from the slave candidate station, the cooperative transmission control unit 103 determines the slave station that actually executes the cooperative transmission processing on the basis of the response signal. The cooperative transmission control unit 103 performs scheduling of the cooperative transmission processing in the slave station to determine a Transmission opportunity (TXOP) period D of the cooperative transmission processing, and generates a schedule signal for notifying the slave station of the TXOP period D.

On the other hand, when the own station becomes a slave candidate station (another base station becomes the master station), the cooperative transmission control unit 103 determines whether or not participation in the cooperative transmission processing with the master station is possible according to the invite signal from the master station, and generates a response signal including a result of the determination. When the cooperative transmission control unit 103 participates in the cooperative transmission processing as the slave station, the cooperative transmission control unit 103 receives the schedule signal from the master station.

With the function of generating and communicating the invite signal, the response signal and the schedule signal of the cooperative transmission control unit 103 as described above, the radio signal processing unit 102 can execute the cooperative transmission processing during the TXOP period D determined by the master station regardless of whether the own station is the master station or the slave station. In the following description, processing for generating and communicating an invite signal, a response signal, and a schedule signal is also called “signaling processing” in the cooperative transmission processing.

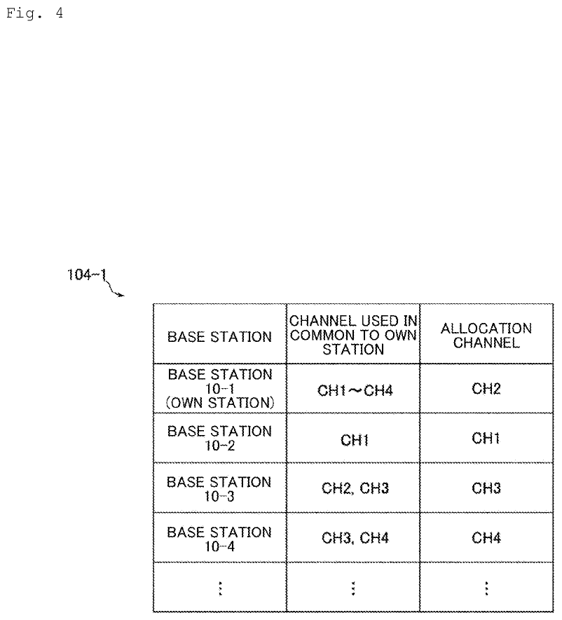

FIG. 4 is a conceptual diagram illustrating a slave candidate station management table that is stored in the base station according to the embodiment. FIG. 4 illustrating a conceptual diagram of a slave candidate station management table 104-1 in the base station 10-1, as an example of the slave candidate station management table 104. That is, in FIG. 4, a base station 10-1 is the own station, and base stations 10-2 to 10-4 are slave candidate stations when the base station 10-1 becomes a master station.

As illustrated in FIG. 4, identification information of the base stations 10-2 to 10-4, “a channel used in common with the own station”, and the “allocation channel” are stored in association with each other in the slave candidate station management table 104-1.

In the example illustrated in FIG. 4, the use of four channels CH1 to CH4 by the base station 10-1 that is the own station is stored in “the channel used in common with the own station” in a first row. In a column of the “allocation channel”, it is stored that at least a channel CH2 is allocated to the base station 10-1 when the base station 10-1 becomes a master station.

In a column of “the channel used in common with the own station” in a second row, it is stored that the channel CH1 is used in common between a plurality of channels that are used by the base station 10-2 and the channels CH1 to CH4 that are used by the base station 10-1. In the column of the “allocation channel”, it is stored that the channel CH1 is allocated from the base station 10-1 to the base station 10-2 when the base station 10-2 becomes a slave station of the base station 10-1.

In the column of “the channel used in common with the own station” in a third row, it is stored that the channels CH2 and CH3 are used in common between a plurality of channels that are used by the base station 10-3 and the channel CH1 and CH4 that are used by the base station 10-1. In the column of the “allocation channel”, it is stored that the channel CH3 is allocated from the base station 10-1 to the base station 10-3 when the base station 10-3 becomes the slave station of the base station 10-1.

In the column of “the channel used in common with the own station” in a fourth row, it is stored that the channels CH3 and CH4 are used in common between a plurality of channels that are used by the base station 10-4 and the channel CH1 and CH4 that are used by the base station 10-1. In the column of the “allocation channel”, it is stored that the channel CH4 is allocated from the base station 10-1 to the base station 10-4 when the base station 10-4 becomes the slave station of the base station 10-1.

Thus, the cooperative transmission control unit 103 of the base station 10-1 can recognize the allocation channels corresponding to the base stations 10-2 to 10-4.

### 1.2 Operation

Next, an operation of the wireless communication system according to the embodiment will be described.

### 1.2.1 Negotiation Processing

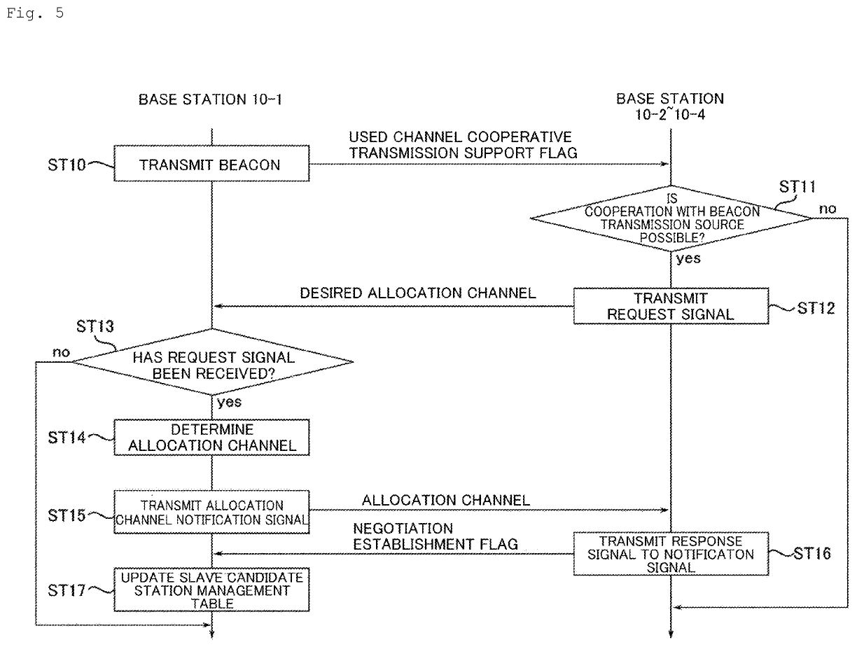

Negotiation processing among base stations according to the embodiment will be described by using a flowchart illustrated in FIG. 5.

In the example in FIG. 5, an example of a case in which negotiation processing is executed between the base station 10-1 and the plurality of base stations 10-2 to 10-4 to determine a slave candidate station when the base station 10-1 becomes a master station is shown.

Negotiation processing is executed in advance before the cooperative transmission processing is executed.

As illustrated in FIG. 5, in step ST10, the base station 10-1 transmits a beacon. The beacon includes, for example, information indicating an address of the own station (the base station 10-1) and one or a plurality of channels to be used by the base station 10-1, and information indicating whether or not the base station 10-1 supports the cooperative transmission processing (a cooperative transmission support flag).

In step ST11, when the base stations 10-2 to 10-4 receive the beacon transmitted from the base station 10-1 in step ST10, the base stations 10-2 to 10-4 determine whether or not cooperation with the base station 10-1 that is a transmission source of the beacon is possible. Specifically, in a case in which the cooperative transmission support flag included in the beacon indicates support of the cooperative transmission processing and the own station uses at least one of channels to be used by the base station 10-1, each of the base stations 10-2 to 10-4 determines that the own station can cooperate with the base station 10-1. Further, for example, in a case in which the cooperative transmission support flag indicates no support of the cooperative transmission processing and the own station does not use any channels to be used by the base station 10-1, each of the base stations 10-2 to 10-4 determines that the own station cannot cooperate with the base station 10-1. When it is determined that the own station can cooperate with the base station 10-1 (step ST11; yes), the processing of the base stations 10-2 to 10-4 proceeds to step ST12, and when it is determined that the own station cannot cooperate with the base station 10-1 (step ST11; no), the processing of the base stations 10-2 to 10-4 skips steps ST12 and ST16 and ends.

In step ST12, each of the base stations 10-2 to 10-4 generates a request signal, and transmits the request signal to the base station 10-1. The request signal corresponds to one type of management frame, and the request signal includes, for example, information indicating a channel of which the allocation is desired by the base station serving as a transmission source (a desired allocation channel) in signaling processing and cooperative transmission processing.

In step ST13, the base station 10-1 determines whether or not the request signal has been received. In a case in which the request signal has been received from at least one base station (step ST13; yes), the processing of the base station 10-1 proceeds to step ST14. On the other hand, in a case in which the request signal has not been received at all (step ST13; no), the processing of the base station 10-1 skips steps ST14, ST15, and ST17 and ends.

In step ST14, the base station 10-1 determines an allocation channel when the base station 10-1 becomes a master station on the basis of at least one received desired allocation channel.

In step ST15, the base station 10-1 generates a notification signal including the determined allocation channel and notifies the base station to which the channel is allocated, of the notification signal.

In step ST16, when the base stations 10-2 to 10-4 receive the notification signal, the base stations 10-2 to 10-4 determines whether or not the base stations participate in cooperative transmission processing using the determined allocation channel. The base stations 10-2 to 10-4 generate a response signal including a negotiation establishment flag including a result of the determination, and transmits the response signal to the base station 10-1.

In step ST17, the base station 10-1 updates the slave candidate station management table 104-1 on the basis of the negotiation establishment flag and the allocation channel.

Thus, the negotiation processing ends.

An arbitrary scheme can be applied as a scheme of determining an allocation channel. Hereinafter, an example of the scheme of determining an allocation channel in a case in which the base station 10-2 desires the channel CH1 and the base station 10-3 and the base station 10-4 desire the channel CH3 in the negotiation processing when the slave candidate station management table 104-1 illustrated in FIG. 4 is generated will be described below.

In the present example, the channel CH1 is desired only by the base stations 10-2. Therefore, the base station 10-1 allocates the channel CH1 to the base stations 10-2 as desired.

On the other hand, in the present example, the channel CH3 is desired by any one of the base stations 10-3 and 10-4. In this case, the base station 10-1 allocates a desired channel to a base station with a high reception power of a signal between the base stations 10-3 and 10-4, for example. In the example illustrated in FIG. 4, in the base station 10-1, the signal from the base station 10-3 has a higher reception power than the signal from the base station 10-4. Therefore, the base station 10-1 allocates the channel CH3 to the base station 10-3.

Although the base station 10-4 desires the channel CH3, the base station 10-4 also uses the channel CH4, in addition to the channel CH3. Therefore, the base station 10-1 allocates the channel CH4 to the base station 10-4 and allocates the remaining channel CH2 to the own station.

Thus, the channel allocation is completed. The base station 10-4 notified of the allocation channel different from the desired allocation channel may determine that the base station does not participate in the cooperative transmission processing in step ST16. In this case, the base station 10-1 allocates the channel CH4 to the own station, in addition to the channel CH2.

The above-described scheme of determining an allocation channel is merely an example. The scheme of determining an allocation channel only requires the channel allocated to the slave candidate station is clarified when the own station finally becomes a master station, and is not limited thereto.

For example, a case in which the base stations 10-2 to 10-4 transmits a request signal on the basis of the beacon transmitted by the base station 10-1 has been described in the example illustrated in FIG. 5, but the present invention is not limited thereto. For example, the base station 10-1 may transmit the request signal with respect to the beacon transmitted by the base stations 10-2 to 10-4. In this case, the base stations 10-2 to 10-4 that has received the request signal can include, in a response signal to the request signal, information of allocation channel desired in the cooperative transmission processing.

### 1.2.2 Transmission Processing

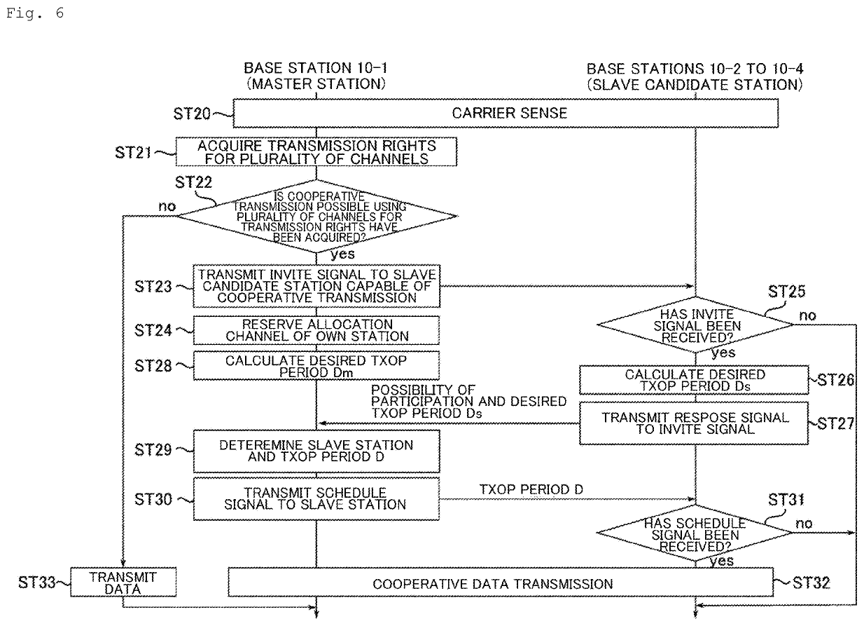

Next, data transmission processing in a plurality of base stations according to the embodiment will be described with reference to the flowchart illustrated in FIG. 6. FIG. 6 illustrates an example of a case in which the base station 10-1 is a master station and the base stations 10-2 to 10-4 are slave candidate stations. Further, hereinafter, a case in which the base station 10-1 acquires transmission rights of the channels CH2 to CH4 and executes cooperative transmission processing with the base stations 10-3 and 10-4 as slave stations among the slave candidate stations 10-2 to 10-4 for convenience of explanation will be described.

As illustrated in FIG. 6, the base stations 10-1 and 10-4 perform carrier sense in step ST20.

In step ST21, the base station 10-1 acquires transmission rights of the plurality of channels. From step ST21, the base station 10-1 functions as a master station. In step ST21, because the base station 10-1 does not determine a base station with which the cooperative transmission processing is to be executed, all the base stations 10-2 to 10-4 stored in the slave candidate station management table 104-1 become slave candidate stations.

In step ST22, the master station 10-1 refers to the slave candidate station management table 104-1 to determine whether or not cooperative transmission processing is possible using the plurality of channels of which the transmission rights have been acquired. When the cooperative transmission is possible (that is, when at least one of a plurality of channels of which the transmission right has been acquired is allocated to the slave candidate station) (step ST22; yes), the processing proceeds to step ST23. On the other hand, when the cooperative transmission is not possible (that is, when all of the plurality of channels of which the transmission rights have been acquired) are not allocated to the slave candidate stations) (step ST22; no), the processing proceeds to step ST33.

In step ST23, the master station 10-1 generates an invite signal for requesting the base stations capable of cooperative transmission among the slave candidate stations 10-2 to 10-4 to participate in the cooperative transmission processing, and transmits the invite signal using a control frame, for example. When there are a plurality of slave candidate stations capable of cooperative transmission, the master station 10-1 transmits the invite signal to the plurality of respective slave candidate stations in parallel using corresponding channels.

For example, when the master station 10-1 acquires the transmission right of the channels CH2 to CH4 in step ST21, the master station 10-1 determines that the slave candidate station 10-3 to which the channel CH3 is allocated and the slave candidate station 10-4 to which the channel CH4 is allocated are capable of cooperative transmission. The master station 10-1 uses the channels CH3 and CH4 to transmit the invite signals to the slave candidate stations 10-3 and 10-4 in parallel. On the other hand, because the master station 10-1 could not acquire the transmission right of the allocation channel CH1 of the slave candidate station 10-2, the master station 10-1 determines that the base station 10-2 is a slave candidate station incapable of cooperative transmission, and does not transmit the invite signal.

Further, in step ST24, the master station 10-1 executes reservation processing, for example, over a transmission period of the invite signal for transmission using the channel CH2 allocated to the own station. Specifically, the base station 10-1 transmits a CTS-to-self (Clear to Send) signal in which an address of the own station is designated as a transmission destination using the channel CH2 (CTS-to-self processing), for example. Accordingly, the master station 10-1 can set a network allocation vector (NAV) in the channel CH2, and use of the channel CH2 by the other base station or the like within a service area of the master station 10-1 can be curbed. A period reserved in the above-described reservation processing may be a period from transmission of the invite signal to transmission of data or may be a TXOP period of the master station 10-1.

The master station 10-1 may execute the processing according to steps ST23 and ST24 in reverse order, or may execute the processing simultaneously.

In step ST25, the slave candidate stations 10-2 to 10-4 determine whether or not the invite signal has been received. When the invite signal is received (step ST25; yes), the processing of the slave candidate station proceeds to step ST26, and when the invite signal is not received (step ST25; no), the processing of the slave candidate station skips steps ST26, ST27, ST31 and ST32 and ends. For example, when the master station 10-1 acquires the transmission right of the channels CH2 to CH4, the processing of the slave candidate station 10-2 ends, but the processing of the slave candidate stations 10-3 and 10-4 proceeds to step ST26.

In step ST26, the slave candidate station that has received the invite signal calculates a desired TXOP period Ds in the cooperative transmission processing. For example, the slave candidate stations 10-3 and 10-4 that have received the invite signal confirm whether or not traffic (downlink data) to be transmitted from the own station to the terminals 20-3 and 20-4 located within the respective service areas are present in the queue. A slave candidate station having downlink data in the queue calculates the TXOP period Ds on the basis of a TXOP period Ds_d necessary for transmission of the downlink data.

The slave candidate stations 10-3 and 10-4 that have received the invite signal may consider a TXOP period Ds_u of traffic (uplink data) to be transmitted from the terminals 20-3 and 20-4 located within respective service areas to the own station, in addition to the TXOP period Ds_d, at the time of calculation of the TXOP period Ds. In this case, the TXOP period Ds may be, for example, a sum of the TXOP period Ds_d and the TXOP period Ds_u (Ds=Ds_d+Ds_u).

When the slave candidate stations 10-3 and 10-4 calculate the TXOP period Ds_u, the slave candidate stations 10-3 and 10-4 previously collect information indicating the TXOP period Ds-u required for transmission of the uplink data from the terminals 20-3 and 20-4 prior to step ST26. More specifically, the respective slave candidate stations 10-3 and 10-4 can periodically poll a report of a buffer status from the terminals 20-3 and 20-4, and receive information indicating the TXOP period Ds-u necessary for transmission of the data when it is confirmed that there is uplink data.

In step ST27, the slave candidate stations 10-3 and 10-4 generate a response signal to the invite signal, and transmit the response signal to the master station 10-1 by using the channels CH3 and CH4 allocated to the own stations. The response signal to the invite signal includes the possibility of participation in the cooperative transmission processing, and the TXOP period Ds calculated in step ST26. This makes it possible for the slave candidate stations 10-3 and 10-4 to notify the master station 10-1 of the TXOP period Ds necessary for the cooperative transmission processing in the own station in parallel with each other.

In step ST28, the master station 10-1 calculates a desired TXOP period Dm in cooperative transmission processing. When the master station 10-1 calculates the TXOP period Dm, the master station 10-1 may consider the TXOP period Dm-u of the uplink data, in addition to the TXOP period Dm-d of the downlink data. In this case, the TXOP period Dm may be, for example, a sum of the TXOP period Dm_d_and the TXOP period Dm_u (Dm=Dm_d+Dm_u).

In step ST29, the master station 10-1 determines slave stations (for example, the base stations 10-3 and 10-4) participating in the cooperative transmission processing on the basis of information on the possibility of participation in the cooperative transmission processing from the slave candidate stations 10-3 and 10-4 received in step ST27. Further, the master station 10-1 determines a TXOP period D of the cooperative transmission processing on the basis of the TXOP period Ds of each slave station received in step ST27 and the TXOP period Dm of the own station calculated in step ST28. For the TXOP period D of the cooperative transmission processing, for example, a maximum value max (Ds, Dm) in the TXOP periods Ds and Dm can be set. When the maximum value max (Ds, Dm) in the TXOP periods Ds and Dm exceeds a set value TXOPlimit in the master station 10-1, the master station 10-1 may determine the set value TXOPlimit as the TXOP period D of the cooperative transmission processing.

In step ST30, the master station 10-1 generates a schedule signal including the TXOP period D determined in step ST29, and transmits the schedule signal to the slave stations 10-3 and 10-4 by using the respective allocated channels CH3 and CH4.

In step ST31, the base stations 10-3 and 10-4 determine whether or not the schedule signal has been received. When the schedule signal is received (step ST31; yes), the processing of the slave station proceeds to step ST32, and when the schedule signal is not received (step ST31; no), the processing of the slave station skips step ST32 and ends.

In step ST32, the master station 10-1 and the slave stations 10-3 and 10-4 execute cooperative data transmission processing. Specifically, the master station 10-1 and the slave stations 10-3 and 10-4 cooperate with each other in the frequency domain and transmit data using the channel CH2 and the channels CH3 and CH4, respectively.

Prior to actual data transmission, the master station 10-1 and the slave stations 10-3 and 10-4 can transmit a trigger frame to the terminals 20-1, 20-3 and 20-4, respectively. The trigger frame is, for example, a frame for the base station 10 notifying the terminal 20 of the number of space streams to be allocated, the frequency of OFDMA, the TXOP period D, and the like. That is, the radio signal processing unit 102 of each of the master station 10-1 and the slave stations 10-3 and 10-4 determines a data transmission and reception schedule within a service area of the own station on the basis of the TXOP period D in the schedule signal when the schedule signal is received. The radio signal processing unit 102 generates a trigger frame including the transmission and reception schedule, and notifies the terminal 20 of the own station of the trigger frame. This makes it possible for the master station 10-1 and the slave stations 10-3 and 10-4 to freely set the transmission and reception schedule in the channel allocated to the own station over the TXOP period D of the cooperative transmission processing.

When the processing proceeds to step ST33, the master station 10-1 executes transmission of data using the plurality of channels for which transmission rights have been acquired, independent of the slave candidate stations 10-2 to 10-4.

Thus, the data transmission processing ends.

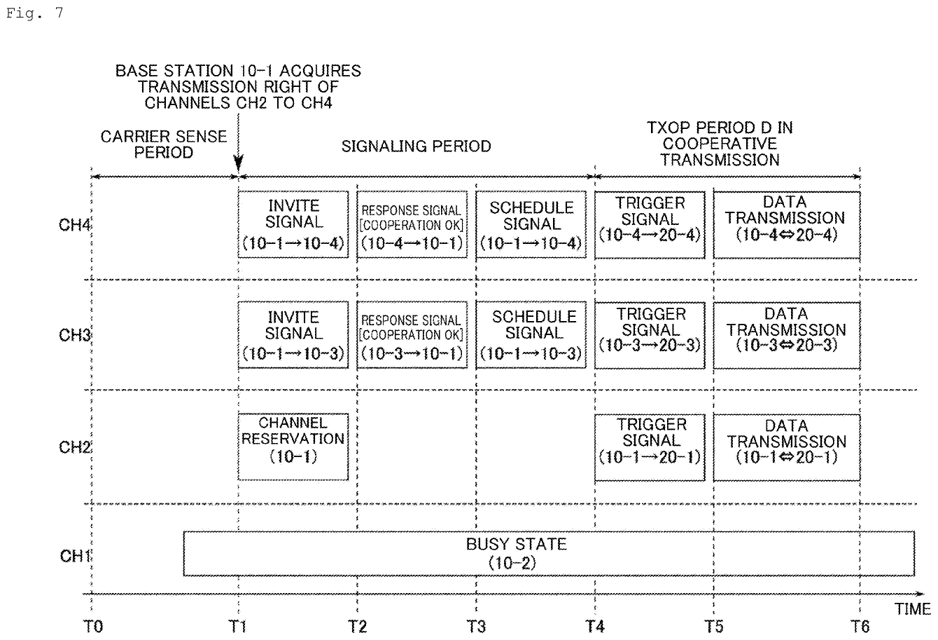

FIG. 7 is a timing chart illustrating data transmission processing by a plurality of base stations according to the embodiment. In FIG. 7, an operation of the base stations 10-1 to 10-4 in the flowchart described in FIG. 6 is shown over a frequency domain (the channels CH1 to CH4) indicated on a vertical axis and a time domain (times T0 to T6) indicated on a horizontal axis. In the time domain in FIG. 7, times T0 and T1 correspond to a carrier sense period in which carrier sense processing is executed, times T1 to T4 correspond to a signaling period in which signaling processing is executed, and times T5 and T6 correspond to a TROP period D in which cooperative transmission processing is executed.

As illustrated in FIG. 7, in step TO, the base stations 10-1 and 10-4 start carrier sense processing. In the example of FIG. 7, a case in which the channels CH1 to CH4 are in an idle state at a point in time TO is illustrated.

At time T1, a carrier sense period set in the base station 10-1 expires, and the base station 10-1 acquires the transmission right of the channels CH2 to CH4. For the channel CH1, the base station 10-2 acquires the transmission right before the time T1 is reached. Therefore, the base station 10-1 recognizes that the channel CH1 is in a busy state and cannot acquire the transmission right.

When the transmission right of the channels CH2 to CH4 is acquired, the base station 10-1 behaves as a master station. Specifically, the slave candidate station management table 104-1 of the own station is referred to, and an invite signal is transmitted to the slave candidate stations 10-3 and 10-4 allocated to the acquired channel CH2 ch4. In this case, the master station 10-1 transmits the invite signal in parallel to the slave candidate stations 10-3 and 10-4 by using the allocation channels CH3 and CH4.

Further, the master station 10-1 executes reservation processing of the channel CH2 through CTS-to-self processing. This makes it possible for the master station 10-1 to curb use of the channel CH2 for other communication until the cooperative data transmission processing is executed.

At time T2, the slave candidate stations 10-3 and 10-4 that have received the invite signal generate response signals and transmit the response signals to the master station 10-1. In this case, the slave candidate stations 10-3 and 10-4 transmit the respective response signals to the master station 10-1 in parallel by using the allocation channels CH3 and CH4.

In the example illustrated in FIG. 7, a case in which both the slave candidate stations 10-3 and 10-4 can participate in the cooperative transmission processing is illustrated. Therefore, the master station 10-1 receives the desired TROP period Ds from both the slave candidate stations 10-3 and 10-4. The master station 10-1 regards the slave candidate stations 10-3 and 10-4 as slave stations on the basis of the response signal, and determines the TXOP period D of the cooperative transmission processing on the basis of the TXOP period Ds in the response signal and the TXOP period Dm calculated in the own station.

At time T3, the master station 10-1 transmits a schedule signal including the determined TXOP period D. In this case, the master station 10-1 transmits the schedule signal in parallel by using the channels CH3 and CH4 allocated to the slave stations 10-3 and 10-4.

The master station 10-1 and the slave stations 10-3 and 10-4 start cooperative data transmission processing at time T4 following a Short Inter Frame Space (SIFS) after transmission or reception of the schedule signal is completed, for example. Specifically, at time T4, the master station 10-1 and the slave stations 10-3 and 10-4 transmit a trigger signal to the terminals 20-1, 20-3, and 20-4 using the channel CH2, CH3, and CH4. This makes it possible for the terminals 20-1, 20-2, 20-3, and 20-4 to recognize the schedule of data transmission or reception to or from the master station 10-1 and the slave stations 10-3 and 10-4 in the TXOP period D.

At time T5, cooperative transmission processing by a radio frame using the channels CH2 to CH4 is started. Specifically, the master station 10-1 and the terminal 20-1 use the channel CH2, the slave station 10-3 and the terminal 20-3 use the channel CH3, and the slave station 10-4 and the terminal 20-4 use the channel CH4 to execute OFDMA communication on the basis of individual schedules.

Thus, the cooperative transmission processing ends.

Various forms can be applied to data transmission between the base station 10 and the terminal 20 during the TXOP period D of the cooperative transmission processing.

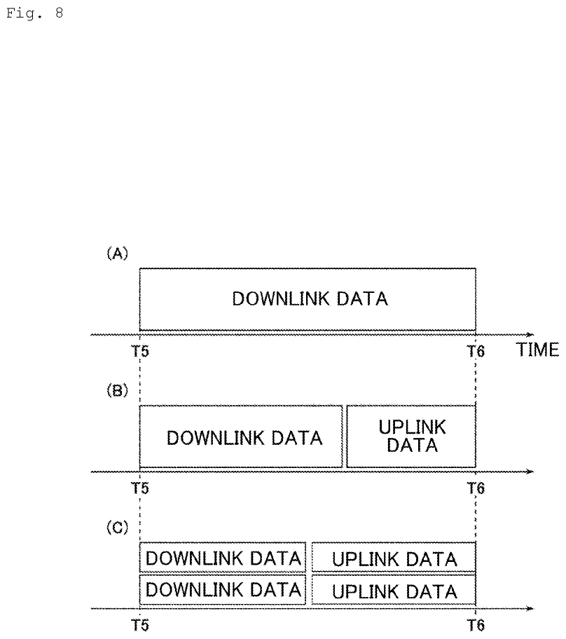

FIG. 8 is a timing chart illustrating data that is communicated between a base station and a terminal in the cooperative transmission processing according to the embodiment. In FIG. 8, some aspects of data transmission between the base station 10 and the terminal 20 during a period from time T5 to time T6 in the TXOP period D in the cooperative transmission illustrated in FIG. 7 are illustrated.

As illustrated in FIG. 8(A), the base station 10 may continue to transmit downlink data to the terminal 20 during the period from time T5 to time T6. Further, as illustrated in FIG. 8(B), the base station 10 may divide the period from time T5 to time T6 into a period in which downlink data is transmitted from the base station 10 to the terminal 20 and a period in which uplink data is transmitted from the terminal 20 to the base station 10 to perform scheduling. Further, as illustrated in FIG. 8(C), the base station 10 may divide the allocated channel into a plurality of frequency resources during a period in which downlink data and uplink data are transmitted, and individually allocate the divided frequency resources to data transmission with the plurality of terminals 20.

In any case, the base station 10 participating in the cooperative transmission processing can freely set an aspect of data transmission with the terminal 20 using the allocated channel in the period from the time T5 to the time T6.

### 1.3 Effects According to Present Embodiment

In the cooperative transmission processing, the master station executes signaling processing with the slave candidate stations to determine a slave station capable of participating in the cooperative transmission processing from among the slave candidate stations. When there are a plurality of slave candidate stations, the master station executes signaling processing individually with the plurality of slave candidate stations. In order to achieve efficient data transmission through cooperative transmission processing, it is preferable to curb an increase in time required for signaling processing even when there are a plurality of slave candidate stations.

According to the present embodiment, when the base station 10-1 acquires the transmission right of the channels CH2 to CH4 and becomes a master station, the base station 10-1 performs signaling with the base station 10-3 using the channel CH3 while performing signaling with the base station 10-4 using the channel CH4. This makes it possible to execute signaling processing among the plurality of base stations 10-3 and 10-4 that are slave candidate stations in parallel. Thus, even when the transmission rights of the plurality of channels can be acquired and the number of slave candidate stations increases, an increase in time required for signaling processing can be curbed. Thus, it is possible to secure a time for executing the cooperative transmission processing, and to use the channel efficiently among the plurality of base stations.

The base station 10-1 executes negotiation processing with the base stations 10-2 to 10-4 before acquiring the transmission rights of the channels CH2 to CH4. Specifically, when the base station 10-1 acquires the transmission rights of the plurality of channels including the channel CH3, the base station 10-1 transmits, to the base station 10-3, a notification signal for notifying that the channel CH3 is allocated in the cooperative transmission processing with the base station 10-3. Further, when the base station 10-1 acquires the transmission rights of the plurality of channels including the channel CH4, the base station 10-1 transmits, to the base station 10-4, a notification signal for notifying that the channel CH4 is allocated in cooperative transmission processing with the base station 10-4. This makes it possible for use of the channel CH3 with the base station 10-3 and use of the channel CH4 with the base station 10-4 to be previously decided between the base stations when the base station 10-1 executes signaling processing as a master station. Therefore, the base station 10-1 can execute signaling processing in parallel with the plurality of slave candidate stations described above. Further, the base station 10-1 can omit signaling processing for the slave candidate stations 10-2 that could not acquire the transmission right of the allocated channel CH1.

In signaling processing, the master station 10-1 transmits an invite signal to the slave candidate stations 10-3 and 10-4 in parallel using the channels CH3 and CH4 allocated to the slave candidate stations 10-3 and 10-4 through negotiation processing. This makes it possible for the slave candidate stations 10-3 and 10-4 to receive a request for participation in the cooperative transmission processing from the master station 10-1 at the same timing.

Further, the respective slave candidate stations 10-3 and 10-4 that have received the invite signal transmit a response signal to the invite signal to the master station 10-1 using the allocated channels CH3 and CH4. This makes it possible for the master station 10-1 to receive the possibility of participation in the cooperative transmission processing and a desired TXOP period Ds in a case of the participation from the plurality of the slave candidate stations 10-3 and 10-4 at the same timing. Thus, the master station 10-1 can determine the TXOP period D in which the cooperative transmission processing is executed on the basis of the TXOP periods Ds and Dm immediately after the response signal is received.

Further, the master station 10-1 transmits a schedule signal including the determined TXOP period D to the slave stations 10-3 and 10-4 in parallel using the allocation channels CH3 and CH4. This makes it possible for the slave stations 10-3 and 10-4 to receive the TXOP period D from the master station 10-1 at the same timing.

### 2. Modification Example and the Like

Various modifications can be made to the above-described embodiment.

### 2.1 First Modification Example

For example, in the above-described embodiment, a case in which both the slave candidate stations 10-3 and 10-4 participate in the cooperative transmission processing as slave stations in the signaling processing has been described, but the present invention is not limited thereto. In this case, the master station 10-1 may further use a channel scheduled to be used by the slave candidate station which does not participate in the cooperative transmission processing. In the following description, description of a configuration and operation that are the same as those of the embodiment will be omitted, and a configuration and operation different from those of the embodiment will be mainly described.

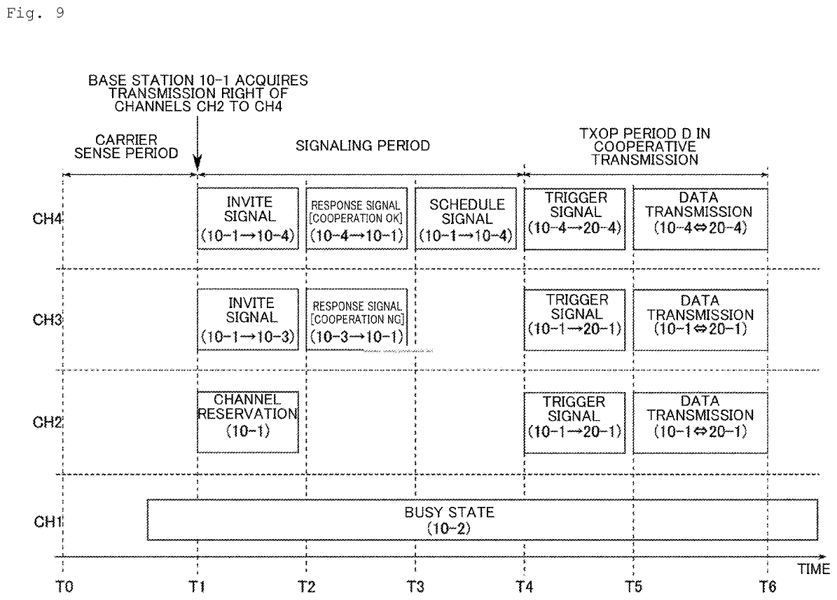

FIG. 9 is a timing chart illustrating data transmission processing in a plurality of base stations according to a first modification example, and corresponds to FIG. 7. In FIG. 9, a case in which the slave candidate station 10-3 does not participate in the cooperative transmission processing is illustrated.

As illustrated in FIG. 9, at time T2, the slave candidate stations 10-3 and 10-4 that have received the invite signal generate response signals and transmit the response signals to the master station 10-1. In this case, the slave candidate station 10-4 notifies the master station 10-1 of information indicating that the station can participate in the cooperative transmission processing, but the slave candidate station 10-3 notifies the master station 10-1 of information indicating that the station does not participate in the cooperative transmission processing. Such a situation may be considered, for example, to be a case in which data to be transmitted to the queue is not present in the slave candidate station 10-3 and the terminal 20-3.

The master station 10-1 regards the slave candidate station 10-4 as a slave station on the basis of the response signal, and determines the TXOP period D of the cooperative transmission processing on the basis of the TXOP period Ds in the response signal and the TXOP period Dm calculated in the own station. In this case, the master station 10-1 can calculate the TXOP period Dm in the own station on the assumption that the own station further uses the channel CH3 scheduled to be used by the slave candidate station 10-3 in addition to the channel CH2. Because the master station 10-1 assumes a case in which the channels CH2 and CH3 have been used, the calculated TXOP period Dm becomes about half of that in a case in which only the channel CH2 has been used, for example.

At time T3, the master station 10-1 transmits a schedule signal including the determined TXOP period D. In this case, the master station 10-1 transmits the schedule signal to the slave station 10-4 using the allocation channel CH4.

At time T4, the master station 10-1 and the slave station 10-4 transmit trigger signals to the terminals 20-1 and 20-4, respectively. In this case, the master station 10-1 uses the channels CH2 and CH3, and the slave station 10-4 uses the channel CH4. This makes it possible for the terminal 20-1 to recognize that data is transmitted or received using the channels CH2 and CH3 to or from the master station 10-1, and for the terminal 20-4 to recognize that data is transmitted or received using the channel CH4 to or from the slave station 10-4.

At time T5, cooperative transmission processing by a radio frame using the channels CH2 to CH4 is started. Specifically, the master station 10-1 and the terminal 20-1 use the channels CH2 and CH3, and the slave station 10-4 and the terminal 20-4 use the channel CH4 to execute OFDMA communication on the basis of individual schedules.

According to the first modification example, when there are a large number of pieces of data to be transmitted in the queue in the master station 10-1, it is possible to shorten the TXOP period Dm as compared with a case in which the master station 10-1 uses only the channel CH2. Accordingly, it is possible to eventually shorten the TXOP period D.

### 2.2 Second Modification Example

Further, in the first modification described above, for example, a case in which the master station 10-1 uses the channel CH3 allocated to the slave candidate station 10-3 that does not participate in the cooperative transmission processing, but the present invention is not limited thereto. For example, the channel CH3 may be used by the slave station 10-4. The following description, description of a configuration and operation that are the same as those of the first modification example will be omitted, and a configuration and operation different from those of the first modification example will be mainly described.

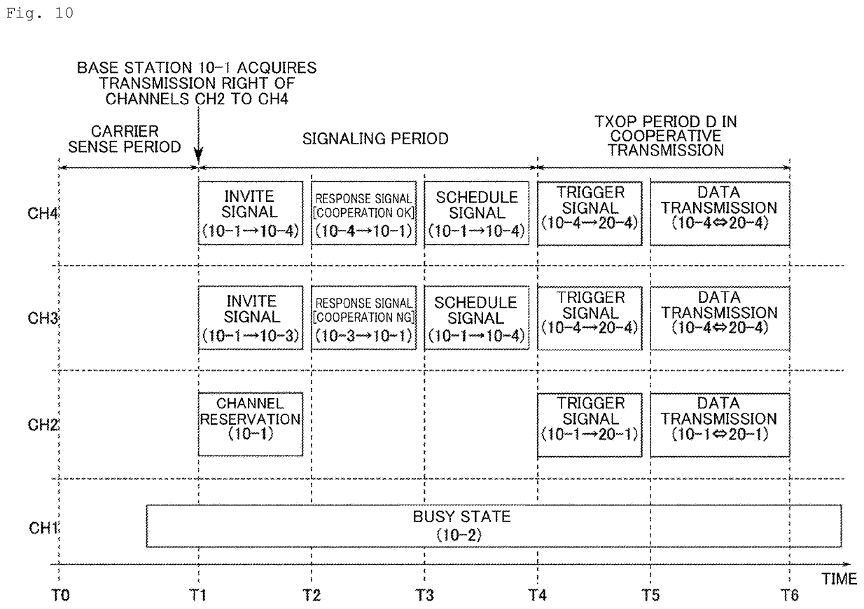

FIG. 10 is a timing chart illustrating data transmission processing in a plurality of base stations according to a second modification example, and corresponds to FIG. 9. In FIG. 10, a case in which the slave station 10-4 uses the channel CH3 in addition to the channel CH4 in the cooperative transmission processing is illustrated.

As illustrated in FIG. 10, when the response signal to the invite signal is received at time T2, the master station 10-1 regards the slave candidate station 10-4 as a slave station on the basis of the response signal, and determines the TXOP period D of the cooperative transmission processing on the basis of the TXOP period Ds in the response signal and the TXOP period Dm calculated in the own station. In this case, the master station 10-1 calculates the TXOP period Ds in the slave station 10-4 again on the assumption that the slave station 10-4 further uses the channel CH3 scheduled to be used by the slave candidate station 10-3 in addition to the channel CH4. Therefore, the TXOP period Ds calculated again by the master station 10-1 is about half of a calculation result of the slave station 10-4, for example.

At time T3, the master station 10-1 transmits a schedule signal including the determined TXOP period D. In this case, the master station 10-1 transmits the schedule signal using the allocation channel CH4 and the schedule signal using the newly allocated channel CH3 to the slave station 10-4 in parallel. When the slave station 10-4 receives the schedule signal on the channel CH3, the slave station 10-4 recognizes that cooperative transmission processing may be executed by using the channel CH3 in addition to the channel CH4.

The master station 10-1 may present a plurality of channels that can be used for cooperative transmission processing to each of the slave candidate stations 10-3 and 10-4, and each of the slave candidate stations 10-3 and 10-4 may present, as a response, a combination of one or more desired channels and a plurality of TROP periods Ds corresponding to the combination. In this case, the master station 10-1 may determine and allocate channels to be used by the slave candidate stations 10-3 and 10-4 in the cooperative transmission processing on the basis of a combination of the plurality of channels included in the response signals of the slave candidate stations 10-3 and 10-4.

At time T4, the master station 10-1 and the slave station 10-4 transmit trigger signals to the terminals 20-1 and 20-4, respectively. In this case, the master station 10-1 uses the channel CH2, and the slave station 10-4 uses the channels CH3 and CH4. Thus, the terminal 20-1 can recognize that data is transmitted or received to or from the master station 10-1 using the channel CH2, and the terminal 20-4 can recognize that data is transmitted or received to or from the slave station 10-4 using the channels CH3 and CH4.

At time T5, cooperative transmission processing by the radio frame using the channels CH2 to CH4 is started. Specifically, the master station 10-1 and the terminal 20-1 use the channel CH2, and the slave station 10-4 and the terminal 20-4 use the channels CH3 and CH4 to execute OFDMA communication on the basis of individual schedules.

According to a second modification example, when there are a large number of pieces of data to be transmitted in the queue in the slave station 10-4, it is possible to shorten the TXOP period Ds as compared with a case in which the slave station 10-4 uses only the channel CH4. Accordingly, it is possible to eventually shorten the TXOP period D.

### 2.3 Others

Each of the processing in the above-described embodiment can be stored as a program that can be executed by a processor that is a computer. In addition, the program can be stored in a storage medium of an external storage device such as a magnetic disk, an optical disc, or a semiconductor memory and distributed. The processor can execute the above-described processing by the program stored in the storage medium of the external storage device being loaded and an operation being controlled by the loaded program.

The present invention is not limited to the above embodiment, and can be modified in various ways without departing from the gist thereof at an implementation stage. Further, respective embodiment may be combined appropriately and implemented and, in this case, combined effects can be achieved. Further, the foregoing embodiment include various inventions, and various inventions can be extracted by combinations selected from the plurality of components disclosed herein. For example, as long as the problem can be solved and the effects can be achieved even when several of the components described in the embodiment are removed, a configuration in which the components have been removed can be extracted as an invention.

### REFERENCE SIGNS LIST

1 Wireless communication system
10-1, 10-2, 10-3, 10-4 Base station
11 Processor
12 ROM
13 RAM
14 Wireless module
15 Router module
20-1, 20-2, 20-3, 20-4 Terminal
101 Data processing unit
102 Radio signal processing unit
103 Cooperative transmission control unit
104 Slave candidate station management table

1. A base station comprising a radio signal processing unit capable of using a first channel, a second channel, and a third channel,
wherein the radio signal processing unit is configured to
perform signaling with a second other base station using the second channel while performing signaling with a first other base station using the first channel when the radio signal processing unit acquires transmission rights of the first channel, the second channel, and the third channel, and
execute cooperative processing with at least one of the first other base station and the second other base station on the basis of a result of the signaling.

2. The base station according to claim 1,
wherein the signaling further includes transmitting, by the base station, a first signal to the second other base station using the second channel while transmitting the first signal to the first other base station using the first channel.

3. The base station according to claim 2, wherein the signaling includes reserving, by the base station, transmission using the third channel while transmitting the first signal.

4. The base station according to claim 2,
wherein the signaling includes receiving a third signal based on the first signal from the second other base station using the second channel while receiving a second signal based on the first signal from the first other base station using the first channel,
the second signal includes first information indicating whether or not the first other base station can participate in the cooperative processing, and
the third signal includes second information indicating whether or not the second other base station can participate in the cooperative processing.

5. The base station according to claim 4,
wherein the signaling includes
transmitting a fourth signal based on the second signal and the third signal to the first other base station using the first channel,
the fourth signal includes third information indicating a TXOP period.

6. The base station according to claim 1,
wherein the radio signal processing unit is configured to
transmit a fifth signal including information indicating that the first other base station is using the first channel to the first other base station, and
transmit a sixth signal including information indicating that the second other base station is using the second channel to the second other base station, before transmission rights of the first channel, the second channel, and the third channel are acquired.

7. The base station according to claim 6,
wherein the radio signal processing unit is configured to
determine whether or not cooperative processing with the first other base station is possible on the basis of a seventh signal when the seventh signal based on the fifth signal is received from the first other base station.

8. A communication method of a base station capable of using a first channel, a second channel, and a third channel, the communication method comprising:
performing signaling with a second other base station using the second channel while performing signaling with a first other base station using the first channel when the base station acquires transmission rights of the first channel, the second channel, and the third channel, and
executing cooperative processing with at least one of the first other base station and the second other base station on the basis of a result of the signaling.

9. A communication program in a base station capable of using a first channel, a second channel, and a third channel, the communication program causing a computer to:
perform signaling with a second other base station using the second channel while performing signaling with a first other base station using the first channel when the base station acquires transmission rights of the first channel, the second channel, and the third channel, and
execute cooperative processing with at least one of the first other base station and the second other base station on the basis of a result of the signaling.
